(19) United States
(12) Patent Application Publication
(10) Pub. No.: US 2025/0311754 A1
(43) Pub. Date: Oct. 9, 2025

(54) COMPOSITION FOR EFFERVESCING AND FLAVORING WATER

(71) Applicant: Sustainable Beverages LLC, Old Lyme, CT (US)

(72) Inventor: Patrick Dagher, Old Lyme, CT (US)

(73) Assignee: Sustainable Beverages LLC, Old Lyme, CT (US)

(21) Appl. No.: 19/169,620

(22) Filed: Apr. 3, 2025

Related U.S. Application Data
(60) Provisional application No. 63/575,538, filed on Apr. 5, 2024.

(51) Int. Cl. A23L 2/40; A23L 2/56; A23L 2/60; A23L 2/68

(52) U.S. Cl. CPC A23L 2/40; A23L 2/56; A23L 2/60; A23L 2/68

(57) ABSTRACT

A composition for effervescing and flavoring water includes 20 to 45 weight percent flavor enhancing ingredient; 10 to 35 weight percent sodium bicarbonate; 10 to 20 weight percent citric acid; 10 to 45 weight percent complex carbohydrate; one or more of: (i) a first natural sweetener comprising 0.1 to 2 weight percent Rebaudioside M; and (ii) a second natural sweetener comprising 0.1 to 2 weight percent Rebaudioside A. The composition is configured to generate bubbles in the water when added to the water and to add flavor and sweetness to the water.

### CROSS REFERENCE TO RELATED APPLICATIONS

This application is a non-provisional application of and claims priority to U.S. Provisional Patent Application No. 63/575,538, entitled “A System and Method for Effervescing and Flavoring Water,” filed Apr. 5, 2024, the entirety of which is incorporated by reference herein.

### TECHNICAL FIELD

The technical field of the present invention is directed to a composition for effervescing and flavoring water, and in particular the composition includes natural sweeteners, flavor enhancing ingredients, an effervescent or bubble forming ingredient and carbonates.

### BACKGROUND

When someone wants a carbonated soft drink on the go, they usually have to go out of their way to a store or vending machine and purchase a bottle of soda. This is not only wasteful, but it can be very inconvenient. The world is becoming more fast paced every day, and people have less time than ever to leave the office, school, or wherever they may be to find somewhere to purchase a bottle of soda. Although one could carry around a bottle of soda everywhere they go, not every place has a recycling bin. Even if there is a recycling bin in the area, the vast majority of recyclables don't actually end up being recycled. According to National Geographic, 91% of plastic does not get recycled and ends up in landfills where it takes hundreds of years to biodegrade. In reality, most people already carry around a reusable water bottle.

Secondary Market Research data indicates that the consumer demand for carbonated beverages is expected to increase over the next few years. In 2022, the market for soft drinks was valued at approximately 257 billion dollars and is expected to increase to 378 billion dollars by 2030. In addition, the reusable water bottle market is highest in Gen Z with 69 percent of Gen Z'ers having a reusable water bottle, leading to the conclusion that our customer profile would fit into this demographic. The global water bottle filling station market, while relatively new, is growing and is expected to grow over the next several years as well. Elkay, the leading company in water bottle filling stations, recently celebrated their production of 1 million filling stations across the country. These water bottle filling stations can be found in gyms, schools, parks, and offices, and they have filled 40 billion bottles to date.

The powdered beverage market is valued at 5 billion dollars in the United States. Market projections expect the market to exceed 11.46 billion dollars by 2034 with a CAGR (Compounded Annual Growth Rate) of 11.3%. This data includes people who will use our beverage product at home when craving a refreshing carbonated beverage. The survey also consisted of different demographics in terms of urbanicity and education level. In terms of gender, 35 percent of our participants were women and 65 percent were men. The survey asked relevant questions such as “do you enjoy a carbonated soft drink?”. About 76 percent of the respondents said they enjoy a carbonated beverage. Another important question that the survey asked was if the respondents would prefer an environmentally friendly product over a regular product and about 91 percent of the respondents said yes.

### SUMMARY

There is disclosed herein a chemical composition for generating bubbles in drinking water, when added to the water and to add flavor and sweetness to the water. The composition includes 20 to 45 weight percent flavor enhancing ingredient; 10 to 35 weight percent sodium bicarbonate; 10 to 20 weight percent citric acid; 10 to 45 weight percent complex carbohydrate; a first natural sweetener comprising 0.1 to 2 weight percent Rebaudioside M; and/or a second natural sweetener comprising 0.1 to 2 weight percent Rebaudioside A.

In some embodiments, the Rebaudioside M is present at a 95 percent purity.

In some embodiments, the Rebaudioside A is present at a 99 percent purity.

In some embodiments, the flavor enhancing ingredient is lime juice powder.

In some embodiments, the lime juice powder is freeze dried.

In some embodiments, the complex carbohydrate is Maltodextrin. The Maltodextrin is added to improve the texture of the composition, increase the shelf life and prevent lumping of the composition.

In some embodiments, the composition is in a powder form.

There is disclosed herein, a preparation (e.g., a pill or powder) with real fruit that utilizes compostable packaging to make an environmentally friendly carbonation creation and convenient alternative to bottled soda. The functionality of the preparation includes being dropped or poured into and then shaken in a bottle holding a predetermined volume of drinking water (e.g., 16 ounces of water) to create a refreshing carbonated beverage. Some features that are included is that the shape of the preparation allows users to drop the preparation in a water bottle bought at a store. This offers consumers more convenience and options when using the product while in no way preventing the product from being used in a normal reusable water bottle.

In some embodiments, the system includes storing and dispensing one or more of the preparations in biodegradable and/or compostable packaging to create a sustainable version of bottled soda. In some embodiments, the packaging is made from a corrugated box with kraft brown matte ink.

There is also disclosed herein a unique method of making the preparation that includes safe ingredients that are approved by the FDA under GRAS (Generally Recognized As Safe).

There is disclosed herein a preparation for effervescing and flavoring water and is a soda pill or powder with real fruit that utilizes compostable or biodegradable packaging to make an environmentally friendly carbonation creation and convenient alternative to bottled soda. The preparation introduces a groundbreaking, real fruit-flavored soda pill or powder in compostable or biodegradable packaging. This aims to transform drinking habits and significantly reduce environmental waste by offering an eco-friendly alternative to bottled soda.

The preparation can be purchased as a soda pill or powder in advance and use it in a reusable water bottle. The preparation can be dropped or poured into any drinking water bottle containing drinking water and create instant soda pop bubbles with fizz. With its minimal package size, the preparation can be stored in a pocket, unlike a traditional bottle of soda. Some things that make the preparation different from powdered drink mixes, is the formula of the preparation and the technology and the packaging.

Another one of competitive advantages is the pill form of the preparation can not only fit in any reusable water bottle, but its slim shape can also fit into any standard bottled water, to give customers the most versatility possible.

The preparation utilizes real fruit as one of the ingredients. Most drink mixes, even “fruit-flavored” ones, are very artificial and don't contain any actual fruit. The preparation includes fruit powder to get the delicious and natural taste.

Our preparation is provided in compostable or biodegradable packaging to create a sustainable version of bottled soda. The functionality of the preparation is that it is to be dropped or poured into, and then shaken in a bottle holding 16 ounces (or other predetermined volume, e.g., 10 to 18 ounces of water) of drinking water to create a refreshing carbonated beverage. This offers consumers more convenience and options when using the product while in no way preventing the product from being used in a normal reusable water bottle. In addition, there is disclosed herein a method of making the pill that includes safe ingredients that are approved by the FDA under GRAS (Generally Recognized As Safe).

The preparation may include, but is not limited to, dextrose, potassium bicarbonate, citric acid, sugar, fruit powder, stevia, monk fruit, aspartame, erythritol, and more.

### BRIEF DESCRIPTION OF THE DRAWINGS

FIG. 1 is a perspective view of the mold of the present invention shown in an open state;

FIG. 2 is a perspective view of the mold of the present invention shown in a closed state;

FIG. 3 is a perspective view of the mold of the present invention shown in a closed state and shown with a blended mix of powders being supplied thereto;

FIG. 4 is a perspective view of the mold of the present invention shown in a closed state and shown with a plunger compressing the blended mix of powders;

FIG. 5 is a perspective view of the mold of the present invention shown in a closed state and shown with a shaping cup inserted into the mold;

FIG. 6 is a schematic view of the preparation in a shaped form along with packaging; and

FIG. 7 is a perspective view of the components of the present invention.

### DETAILED DESCRIPTION

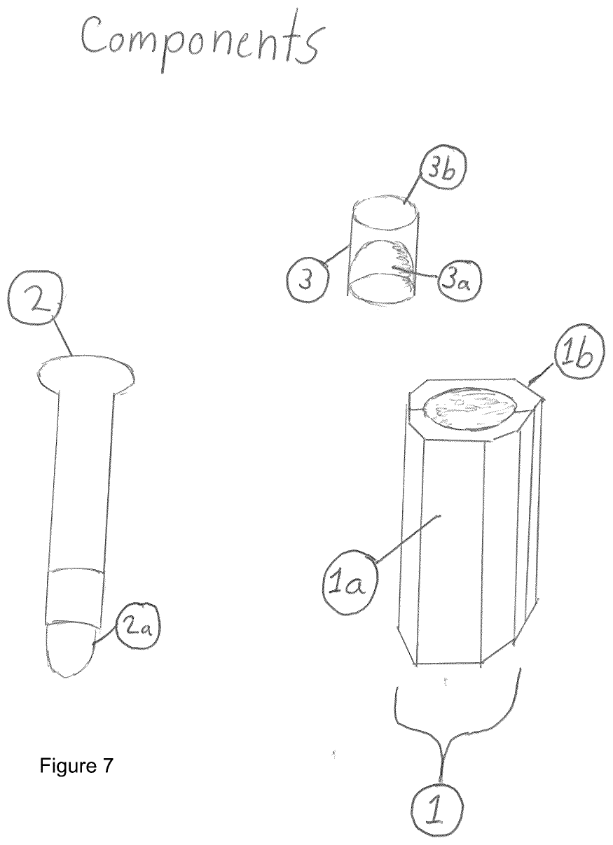

As shown in FIG. 7, the present invention includes a mold 1, which has a first segment 1a and a second segment 1b; a plunger 2, with a dome shaped end 2a; a shaping cup 3, which has a shaping surface 3a and a top axial end 3b.

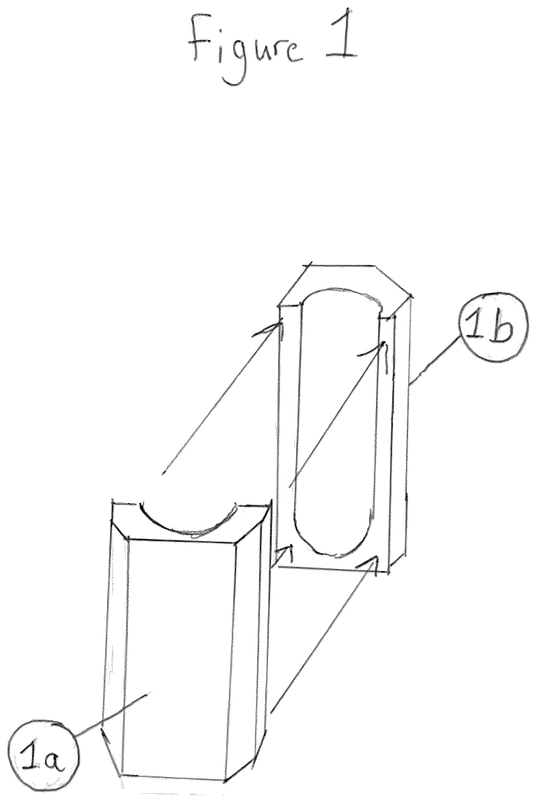

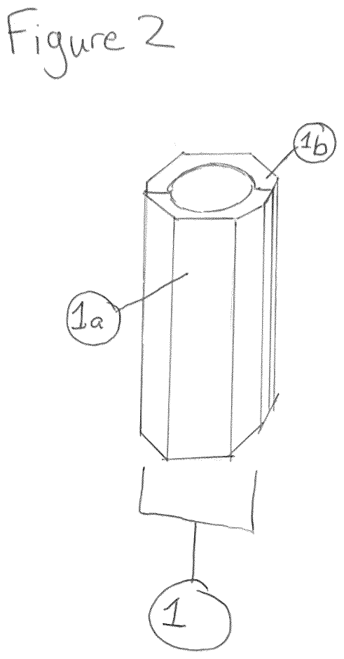

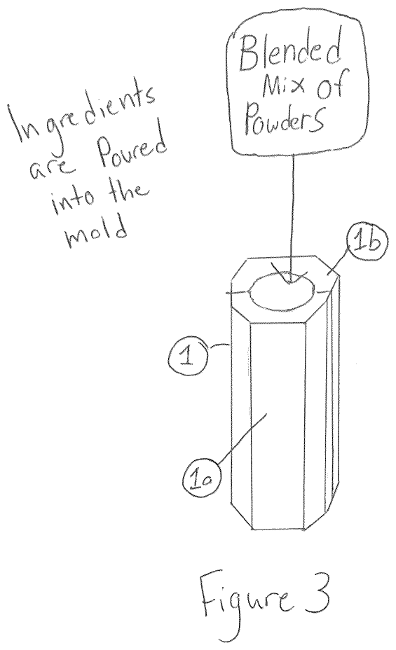

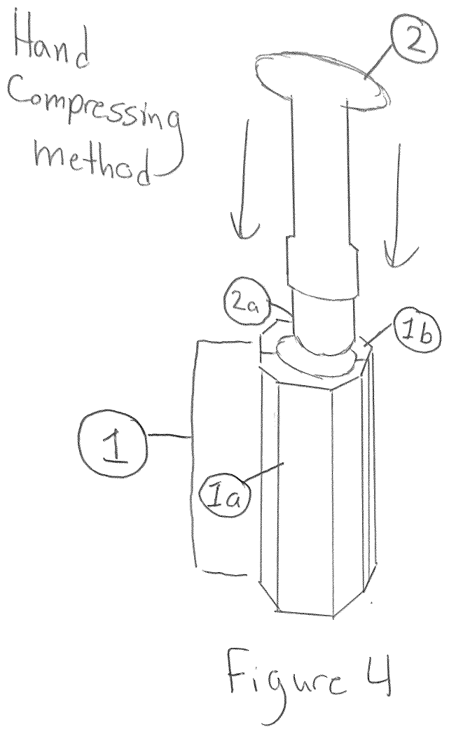

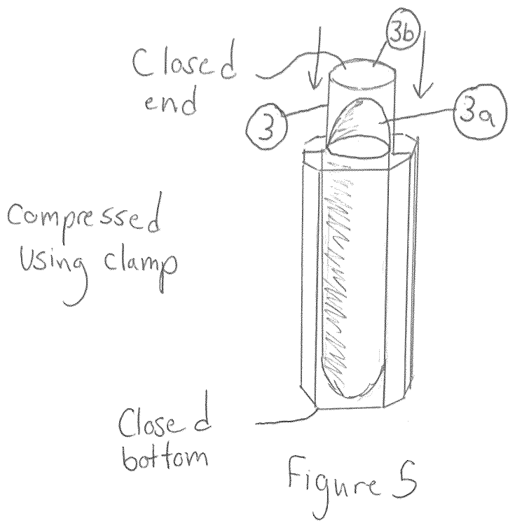

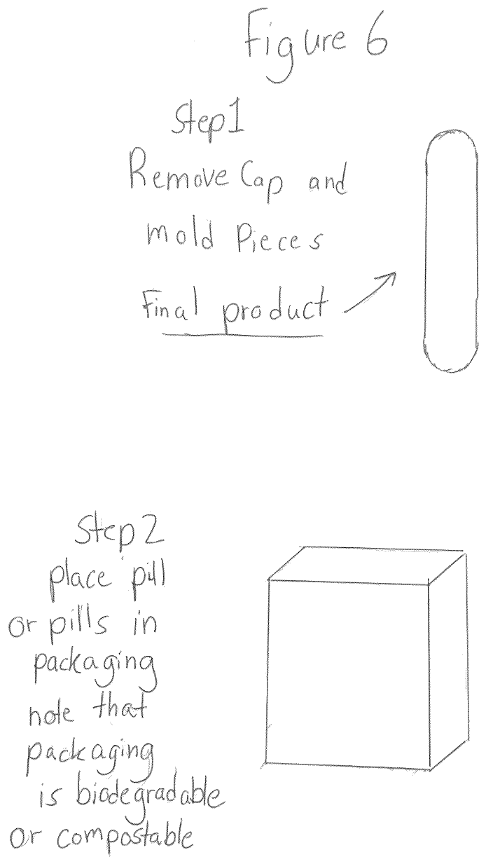

A shown in the FIGS., the components of the present invention refer to the mold and compression (plunger), shaping tools. FIG. 1. Mold sides are put together and secured by a single fastener means. FIG. 2. Fastened mold can fit 5 grams to 35 grams of blended mix of powders FIG. 3. Ingredients are mixed together to create the blended mix of powder. This mix is poured into mold until desired amount is reached FIG. 4. The ingredients in the mold are then hand pressed using the plunger. Applying hand pressure. Pressure could be applied once or multiple times. FIG. 5. Remove plunger and put shaping cup on mold and clamp or fasten the shaping cup to the mold. Apply pressure to shaping cup using clamp or fastening tool. Leave clamp or fastening tool on for 30 minutes to 72 hours. FIG. 6. Remove clamp and all components. Place the finished product, the effervescent pill or multiple pills, in compostable or biodegradable packaging.

The preparation (also referred to herein as a pill or tablet) is made from raw materials. While the preparation is described as being in a solid pill or tablet form, the present invention is not limited in this regard as in some embodiments the preparation is a composition in powder form. The preparation is placed into the packaging by manual or automatic means.

The preparation (e.g., effervescent pill or tablet, or powder composition) utilizes real fruit and is packaged in a biodegradable or compostable package. In some embodiments, the packaging is home compostable, industrial compostable, or biodegradable.

In some embodiments, the packaging is shaped like a box, a bag, a pouch, a cylinder or other suitable shape.

The preparation may be white, red, green, orange, or any other color.

The shape of either end of the pill may be in a V-shape, circular, flat, cone-shaped, dome-shaped, cylinder, ovular, rectangular, square triangular, diamond shaped.

The pill can be compressed using a plunger with a clamp, or with a pill press, or compressed by hand.

The preparation is made with real fruit. In some embodiments, the fruit is in solid or powder form. In some embodiments, fruit and fruit powder is freeze dried or dehydrated. In some embodiments, the fruit is crystallized fruit powder.

In some embodiments, the fruit in the preparation is made from real fresh fruit found in nature, from a farm, from a store, or from a supplier. In some embodiments, artificial fruit or made in a lab is employed.

The fruit in the preparation could be any fruit or flavoring. The fruit could be, but is not limited to watermelon, lime, lemon, strawberries, grapes, oranges, and combinations thereof as well as other types of fruit.

The flavor is not limited to watermelon, lime, lemon, lemon-lime, strawberry, grape, orange, cola, and other flavors.

In some embodiments, the flavor is in the form of whole fruit powder, fruit juice powder, straight fruit juice, or straight fruit. Any part of the fruit may be used in the production of the pill, including dehydrated or freeze dried fruit juice or whole fruit powder.

The pill mold may be 6-sided, a perfect cylinder, a rectangle, a square, or a prism.

In some embodiments, the preparation is a chemical composition that includes 20 to 45 weight percent flavor enhancing ingredient; 10 to 35 weight percent sodium bicarbonate; 10 to 20 weight percent citric acid; 10 to 45 weight percent complex carbohydrate; a first natural sweetener comprising 0.1 to 2 weight percent Rebaudioside M (i.e., SteviaSweet RM95, a natural sweetener from Icon Foods, is primarily composed of Rebaudioside M (Reb M), a steviol glycoside derived from the Stevia rebaudiana plant); and/or a second natural sweetener comprising 0.1 to 2 weight percent Rebaudioside A (i.e., Stevia Sweet RA99, a high-purity stevia extract, primarily consists of Rebaudioside A (Reb. A), a sweet molecule/steviol glycoside found in the Stevia plant). The composition is configured to generate bubbles in the drinking water when added to the water and to add flavor and sweetness to the drinking water.

In some embodiments, the Rebaudioside M is present at a 95 percent purity.

In some embodiments, the Rebaudioside A is present at a 99 percent purity.

In some embodiments, the flavor enhancing ingredient is lime juice powder.

In some embodiments, the lime juice powder is freeze dried.

In some embodiments, the complex carbohydrate is Maltodextrin. The Maltodextrin is added to improve the texture of the composition, increase the shelf life, and prevent lumping of the composition.

In some embodiments, the composition is in a powder form, for example, a dry powder.

In some embodiments, the composition includes minerals and/or vitamins.

### EXAMPLE

A 100 gram sample of the composition powder (e.g., dry powder) includes the following ranges of ingredients:

| Ingredient | Grams |
|---|---|
| Lime Juice Powder | 20-45 grams |
| Sodium Bicarbonate | 10-35 grams |
| Citric Acid | 10-20 grams |
| Stevia Sweet RM95 | 0.1-2 grams |
| Stevia Sweet RA99 | 0.1-2 grams |
| Maltodextrin | 10-45 grams |

In some embodiments, the preparation is a chemical composition that includes 30 to 42 weight percent flavor enhancing ingredient; 15 to 30 weight percent sodium bicarbonate; 12 to 18 weight percent citric acid; 15 to 30 weight percent complex carbohydrate; a first natural sweetener comprising 0.1 to 2 weight percent Rebaudioside M; and/or a second natural sweetener comprising 0.1 to 2 weight percent Rebaudioside A).

In some embodiments, the composition includes the first natural sweetener comprising 0.1 to 4 weight percent Rebaudioside M and no second natural sweetener.

In some embodiments, the composition includes the second natural sweetener comprising 0.1 to 4 weight percent Rebaudioside A and no first sweetener.

The following embodiments are also contemplated as part of the present invention and are introduced below as items.

Item 1. A system for effervescing and flavoring water, the system comprising: a preparation having a formula comprising a bubble forming chemical composition, the chemical composition being reactive with water to generate bubbles in the water when the preparation is placed in the water; and the preparation being of a solid unitary form and being configured to dissolve in water.

Item 2. The system of item 1, further comprising: a container comprising a compostable and/or biodegradable material; and at least one of the preparations being stored in and dispensable from the container.

Item 3. The system of item 2, wherein the compostable and/or biodegradable material is paper pulp-based.

Item 4. The system of item 1, further comprising a flavor enhancing ingredient.

Item 5. The system of item 1, further comprising citric acid.

Item 6. The system of item 1, further comprising a carbonate.

Item 7. The system of item 6, wherein the carbonate is at least one of sodium carbonate and potassium bicarbonate.

Item 8. An apparatus for manufacturing the preparation of item 1, the apparatus comprising: a mold having an interior area, extending from a first axial end to a second axial end of the mold, the first axial end having a first opening in communication with the interior area, the second axial end being configured to be closed off, the mold being a split mold having at least a first segment and a second segment engageable and separable from one another; a shaping cup having a contoured interior surface and a outside surface that comports with a shape of the interior area of the mold, the shaping cup having an axial engagement edge on one end thereof; and a plunger configured to enter the interior area and engage the axial engagement edge of the shaper cup and to force the shaping cup into the interior area.

Item 9. The apparatus of item 8, further comprising a fastener arrangement configured to removably surround and engage an exterior area of the mold to hold the first segment and the second segment against one another and to selectively release the first segment and the second segment from one another.

Item 10. A method of manufacturing the preparation of item 1, comprising the steps of: providing a mixture of dextrose and optionally water, a blend of effervescent powder and optionally a flavoring; inserting the mixture of dextrose and with or without water, the blend of effervescent powder and optionally the flavoring into the interior area of the mold; mixing the mixture of dextrose and with or without water, the blend of effervescent powder and optionally the flavoring into the interior area of the mold to create a combined mixture; and compressing the combined mixture in the mold using the plunger to create the preparation.

Item 11. The method of item 10, wherein the compressing comprises applying a force to the plunger via an actuator.

Item 12. The method of item 11, wherein the actuator is one of a human hand and a pneumatic actuator.

Item 13. The method of item 10, wherein the combined mixture is maintained in the mold for a predetermined time of 30 minutes to 72 hours at ambient temperature.

Item 14. The method of item 10, wherein the preparation is removed from the mold by separating the first segment from the second segment.

The disclosure is not limited to the foregoing illustrative examples and the examples should be considered in all respects as illustrative and not restrictive, reference being made to the appended claims, rather than to the foregoing examples, and all changes which come within the meaning and range of equivalency of the claims are therefore intended to be embraced.

In the specification, the singular forms also include the plural forms, unless the context clearly dictates otherwise. Unless defined otherwise, all technical and scientific terms used herein have the same meaning as commonly understood by one of ordinary skill in the art to which this invention belongs. In the case of conflict, the present specification will control.

What is claimed is:

1. A composition for effervescing and flavoring water, the composition comprising:
20 to 45 weight percent flavor enhancing ingredient;
10 to 35 weight percent sodium bicarbonate;
10 to 20 weight percent citric acid;
10 to 45 weight percent complex carbohydrate;
at least one of:
(i) a first natural sweetener comprising 0.1 to 2 weight percent Rebaudioside M; and
(ii) a second natural sweetener comprising 0.1 to 2 weight percent Rebaudioside A;
wherein the composition is configured to generate bubbles in the water when added to the water and to add flavor and sweetness to the water.

2. The composition of claim 1, wherein the Rebaudioside M is present at a 95 percent purity.

3. The composition of claim 1, wherein the Rebaudioside A is present at a 99 percent purity.

4. The composition of claim 1, wherein the flavor enhancing ingredient is lime juice powder.

5. The composition of claim 4, wherein the lime juice powder is freeze dried.

6. The composition of claim 1, wherein the complex carbohydrate is Maltodextrin.

7. The composition of claim 1, wherein the composition is in a powder form.
